(19) United States
(12) Patent Application Publication
(10) Pub. No.: US 2006/0095152 A1
(43) Pub. Date: May 4, 2006

(54) Receiving solid freeform fabrication (SFF) job

(76) Inventor: Stephen A. Loughran, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/976,636

(22) Filed: Oct. 29, 2004

(51) Int. Cl. G06F 19/00

(52) U.S. Cl. 700/119; 700/182

(57) ABSTRACT

In a method of an embodiment of the invention, a fabrication is received over a network from a first solid freeform fabrication (SFF) system, by a second SFF system. The second SFF system fabricates a physical object based on the fabrication job received, without user intervention in loading the fabrication job into the second SFF system.

### BACKGROUND OF THE INVENTION

Solid freeform fabrication (SFF) encompasses technologies that are employed to fabricate physical objects directly from computer-aided drafting (CAD) data sources. SFF is also referred to as freeform fabrication (FFF), rapid prototyping, and layered manufacturing. In SFF, physical objects are fabricated in a layer-by-layer manner. The material of each layer is bonded to the material of the immediately adjacent layers. Such additive technology provides for advantages over classic subtraction fabrication methods such as milling. For instance, objects can be formed with any geometric complexity or intricacy without the need for elaborate machine setup or final assembly. Furthermore, the construction of complex objects is reduced to a manageable, straightforward, and relatively fast process. Engineers, surgeons, architects, and artists, among other disciplines, routinely use SFF.

Submission of SFF fabrication jobs from a user to an SFF fabricator can be laborious, however. Where the client device of the user, such as a computing device like a desktop computer running CAD software, is remotely located relative to the SFF system of the SFF fabricator, the user is usually required to manually send an SFF fabrication job to the SFF fabricator, either electronically or via delivery service. The SFF fabricator then manually inspects the SFF fabrication job submitted to verify that the fabricator's SFF system is able to accommodate the job, before scheduling the job for fabrication. Such manual user intervention at the SFF fabricator can result in delays in fabrication of the SFF fabrication job. As an example, the job may be sent late Friday afternoon, and the fabricator may not examine the job until Monday morning, wasting the weekend, when fabrication by the SFF system could have already been underway.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a diagram of a rudimentary system, including two solid freeform fabrication (SFF) system, according to an embodiment of the invention.

FIG. 2 is a diagram of the process by which a first SFF system receives a SFF system description file (SDF) from a second SFF system, according to an embodiment of the invention.

FIG. 3 is a diagram depicting how a first SFF system is able to send SFF fabrication jobs to different addresses of a second SFF system, according to an embodiment of the invention.

FIG. 4 is a diagram depicting how an SFF system is able to assign a job priority to an SFF fabrication job depending on the network address at which the job is received, according to an embodiment of the invention.

FIG. 5 is a diagram depicting how an SFF system is able to deduct the job fabrication cost of an SFF fabrication job from an account corresponding to the network address at which the job is received, according to an embodiment of the invention.

FIG. 6 is a diagram of an SFF system in detail, according to an embodiment of the invention.

FIG. 7 is a flowchart of a method performable by an SFF system, according to an embodiment of the invention.

FIG. 8 is a diagram of another SFF system in detail, according to an embodiment of the invention.

FIG. 9 is a flowchart of a method performable by an SFF system, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

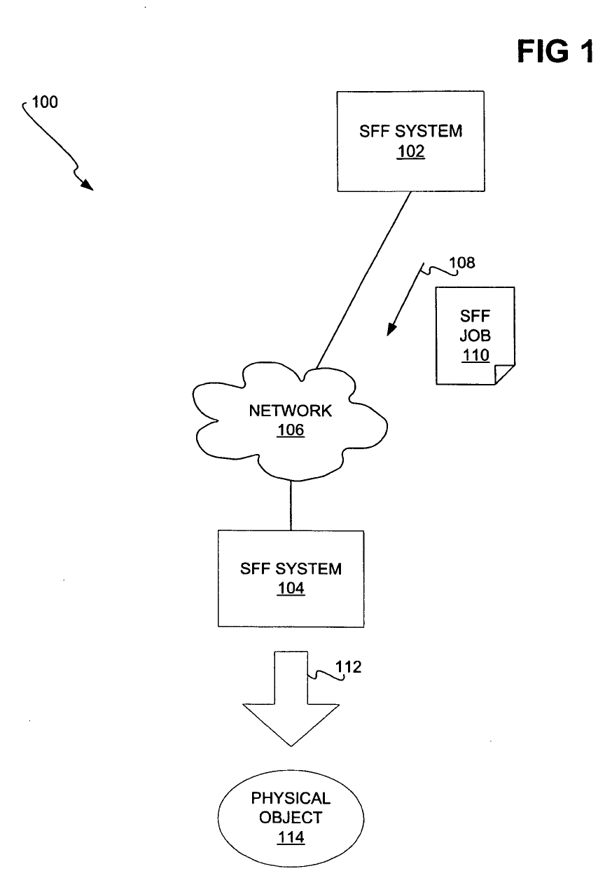

FIG. 1 shows an overview of a system 100, according to an embodiment of the invention. Other aspects of the system 100 in various embodiments thereof are described in relation to subsequent figures of the drawings. The system 100 includes a first solid freeform fabrication (SFF) system 102 and a second SFF system 104, which are communicatively coupled to one another via a network 106. The first SFF system 102 may be or include a general-purpose computing device, like a desktop, portable, or server computer running computer-aided drafting (CAD) software. The first SFF system 102 may also be another type of device other than a general-purpose computing device. In some embodiments of the invention, the first SFF system 102 may be considered a client to the second SFF system 104, in that the first SFF system 102 provides SFF jobs to the second SFF system 104, and the second SFF system 104 fabricates these jobs. Only one such client is depicted in FIG. 1 for illustrative convenience, and in other embodiments there may be more than one such client. Furthermore, the network 106 may be or include one or more of: the Internet, an intranet, an extranet, a wired network, a wireless network, and a telephony network, among other types of networks.

The second SFF system 104 fabricates physical objects from SFF fabrication jobs in a layer-by-layer manner. SFF may also be referred to as freeform fabrication (FFF), rapid prototyping, and layered manufacturing, and these terms are used interchangeably and synonymously herein. The second SFF system 104 may be or include in particular one or more of: a selective laser sintering SFF system, a stereo lithography SFF system, a wide-area thermal inkjet SFF system, a fused deposition modeling SFF system, a single jet inkjet SFF system, a three-dimensional printing SFF system, and a laminated object manufacturing SFF system, among other types of SFF systems. Each of these different types of SFF systems is now briefly described.

In a selective laser sintering SFF system, a roller spreads thermoplastic powder over the surface of a build cylinder. The piston in the cylinder moves down one object layer thickness to accommodate the new layer of powder. The powder delivery system is similar in function to the build cylinder. A piston moves upward incrementally to supply a measured quantity of powder for each layer. A laser beam is then traced over the surface of this tightly compacted powder to selectively melt and bond it to form a layer of the object. The fabrication chamber is maintained at a temperature just below the melting point of the powder so that heat from the laser need only elevate the temperature slightly to cause sintering. The process is repeated until the entire object is fabricated.

In a stereo lithography SFF system, plastic objects are built a layer at a time by tracing a laser beam on the surface of a vat of liquid photopolymer. This class of materials quickly solidifies wherever the laser beam strikes the surface of the liquid. Once one layer is completely traced, it is lowered a small distance into the vat and a second layer is traced right on top of the first. The self-adhesive property of the material causes the layers to bond to one another and eventually form a complete, three-dimensional object after many such layers are formed.

In a wide-area thermal inkjet or a single jet inkjet SFF system, a jet for each of a plastic build material and a wax-like support material is used. The materials are held in a melted liquid state in reservoirs. The liquids are fed to individual jetting heads that squirt tiny droplets of the materials in the required pattern as they are moved to form a layer of the object. The materials harden by rapidly dropping in temperature as they are deposited. After jetting forms an entire layer of the object, a milling head is passed over the layer to make it a uniform thickness. Particles are vacuumed away as the milling head cuts and are captured in a filter. The process is repeated to form the entire object.

In a fused deposition modeling SFF system, a plastic filament is unwound from a coil and supplies material to an extrusion nozzle. The nozzle is heated to melt the plastic and has a mechanism that allows the flow of the melted plastic to be turned on and off. The nozzle is mounted to a mechanical stage that can be moved in both horizontal and vertical directions. As the nozzle is moved over the table in the required geometry, it deposits a thin bead of extruded plastic to form each layer. The plastic hardens immediately after being squirted from the nozzle and bonds to the layer below. The entire system is contained within a chamber that is held at a temperature just below the melting point of the plastic.

In a three-dimensional printing SFF system, a layer of powder object material is deposited at the top of a fabrication chamber. To accomplish this, a measured quantity of powder is first dispensed from a similar supply chamber, such as by moving a piston upward incrementally. A roller then distributes and compresses the powder at the top of the fabrication chamber. A multi-channel jetting head subsequently deposits a liquid adhesive in a two dimensional pattern onto the layer of the powder which becomes bonded in the areas where the adhesive is deposited, to form a layer of the object. Once a layer is completed, the fabrication piston moves down by the thickness of a layer, and the process is repeated until the entire object is formed within the powder bed. After completion, the object is elevated and the extra powder removed.

In a laminated object manufacturing SFF system, profiles of object cross sections are cut from paper or other web material using a laser. The paper is unwound from a feed roll onto the stack and first bonded to the previous layer using a heated roller that melts a plastic coating on the bottom side of the paper. The profiles are then traced by an optics system that is mounted to a stage. After cutting of the layer is complete, excess paper is cut away to separate the layer from the web. Waste paper is wound on a take-up roll. Areas of cross sections that are to be removed in the final object are heavily crosshatched with the laser to facilitate removal.

Still referring to FIG. 1, the first SFF system 102 generates an SFF fabrication job 110. The SFF fabrication job 110 may be generated by CAD software running on the first SFF system 102. The SFF fabrication job 110 describes a physical object to be fabricated by the second SFF system 104. For example, the SFF fabrication job 110 may be a machine-readable data file that includes the dimensions, materials, and other description of a physical object to be fabricated by the second SFF system 104. The SFF fabrication job 110 is recited synonymously herein as the SFF job 110, as the fabrication job 110, and also simply as the job 110.

The first SFF system 102 sends the SFF fabrication job 110 to the second SFF system 104 over the network 106, as indicated by the arrow 108. The transmission of the job 110 to the second SFF system 104 from the first SFF system 102 may be accomplished in a number of different ways. In one embodiment, a store-and-forward technique is used to transmit the job 110 from the first SFF system 102 to the second SFF system 104. Store-and-forward involves the temporary storage of a message, in this case an SFF fabrication job, for transmission to its destination at a later time. Store-and-forward techniques allow for routing over networks that are not accessible at all times. Such techniques enable intermittently connected devices such as laptops to queue messages until connectivity is possible. More critically, store-and-forward, or relay, techniques permit messages to be sent to a recipient that is not directly visible to the sender. Specifically, if the second SFF system 104 is behind a firewall and the first SFF system 102 is on a public network, the first SFF system 102 is not able to directly send a message to the second SFF system 104.

In another embodiment, the transport of the SFF fabrication job 110 to the second SFF system 104 from the first SFF system 102 is accomplished via email, which is one particular example of a store-and-forward technique. The fabrication job 110 may be an attachment to an email message, or the job 110 may be the body of the email message. A particularly defined protocol may be used in conjunction with the email delivery. For instance, the fabrication job 110 may be sent as an extensible Markup Language (XML) file, where the underlying transport is the Simple Object Access Protocol (SOAP) over the Simple Mail Transport Protocol (SMTP). As another example, a relay protocol such as the extensible Messaging and Presence Protocol (XMPP) can be used. Thus, a publicly visible relay system relays messages from the first SFF system 102 to the second SFF system 104. The job 110 is then delivered in one or more XMPP messages, to an XMPP entity address, known as a “Jabber Identifier”.

The message in which the SFF fabrication job 110 is transported from the first SFF system 102 to the second SFF system 104 over the network 106 may be encrypted to provide for security. For example, the first SFF system 102 may have a public encryption key of the second SFF system 104 so that it is able to encrypt the email message. Once the encrypted message is received, the second SFF system 104 decrypts the message using its corresponding private encryption key. Furthermore, the message in which the job 110 is being transported may be digitally signed by the first SFF system 102, so that the second SFF system 104 is able to authenticate the sender of the job 110. For either or both encryption and authentication, the second SFF system 104 can in one embodiment be the repository and/or issuer of the public and private keys used. In addition, simpler, but not as secure, authentication can be accomplished by the second SFF system 104 examining the sender identity of the messages containing SFF fabrication jobs, and accepting only those jobs that are received from known users. It is noted that the second SFF system 104 is more particularly concerned with authenticating the identity of the sender of an SFF fabrication job, as opposed to the device from which it was sent.

Once the second SFF system 104 has received the SFF fabrication job 110 from the first SFF system 102 over the network 106, it is able to load the fabrication job 110 so that fabrication of a physical object based on, or in accordance with, the job 110, without user intervention. That is, administrators, technicians, or other personnel of the provider of the second SFF system 104 do not need to manually inspect the job 110 to manually approve loading of the job 110 for fabrication of a physical object based thereon. Thus, a user or customer having the first SFF system 102 is able to send SFF fabrication jobs to the second SFF system 104 at any time of day, and the second SFF system 104 can begin fabrication of physical objects in accordance therewith. Such automated SFF fabrication job receipt by the second SFF system 104 from the first SFF system 102 over the network 106 is an advantage provided by embodiments of the invention.

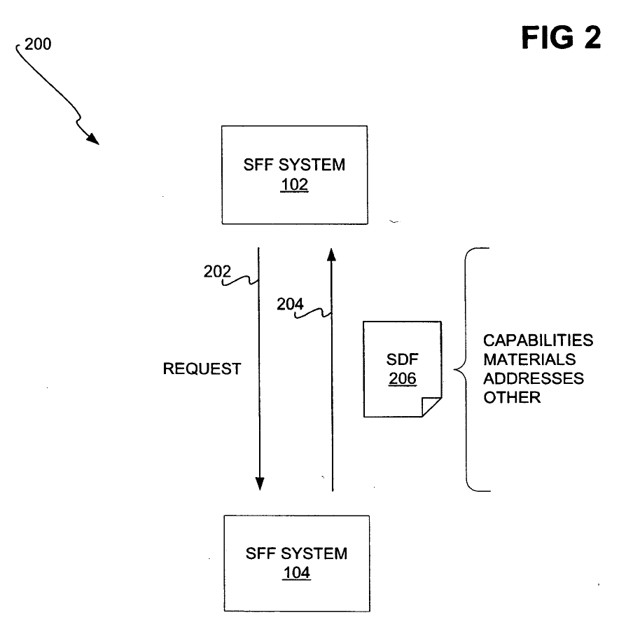

For unattended SFF fabrication job receipt and physical object fabrication to occur, or for such job receipt and object fabrication to occur without user intervention, the first SFF system 102 desirably has to have knowledge of the capabilities, materials, and different network addresses of the second SFF system 104. FIG. 2 shows a scenario 200 by which the first SFF system 102 receives a system description file (SDF) 206 from the second SFF system 104 in order to acquire this knowledge, according to an embodiment of the invention. The network 106 of FIG. 1 is not depicted in FIG. 2 for illustrative convenience and clarity. The first SFF system 102 sends a request to the second SFF system 104, as indicated by the arrow 202, where the first SFF system 102 has already obtained or otherwise has a general address of the second SFF system 104 to send this request. For instance, the query may be sent via email to a general and publicly available email address of the second SFF system 104, or by another approach. The second SFF system 104 may have a publicly accessible Internet web site at which this email address can be obtained, or the second SFF system 104 may broadcast its address on a network to which the first SFF system 102 has access. As another example, the second SFF system 104 may have previously provided an invitation to the first SFF system 102 that includes this address.

The second SFF system 104, in response to the query, sends the SDF 206 back to the first SFF system 102, as indicated by the arrow 204. The SDF 206 contains some or all of the information indicated by the reference number 208. For instance, the SDF 206 may describe the capabilities of the second SFF system 104, such as the manner by which SFF is performed, the speed at which SFF is performed, the costs associated with SFF, and so on. The SDF 206 may include the materials from which the second SFF system 104 can fabricate physical objects, as well as the materials that the second SFF system 104 has currently loaded thereinto. The SDF 206 may further include network addresses of the second SFF system 104 at which the second SFF system 104 is able to receive SFF fabrication jobs from the first SFF system 102. For example, when SMTP is used as the underlying transport of jobs these network addresses are email addresses. The SDF 206 may include public keys of the second SFF system 104 for encryption and other purposes.

The SDF 206 may also include other information that describes the second SFF system 104. Such other information may include the name and location of the second SFF system 104, its time zone of operation, the contact name and phone number of one or more personnel responsible for the second SFF system 104, and so on. The physical characteristics of the second SFF system 104 described within the SDF 206 may include model type, build bin size, build time per layer, cost per weight of part and support materials, fabrication process, supported formats, as well as other items of relevance. Thus, first SFF system 102 can thus use this information to determine what types of physical objects the second SFF system 104 is able to fabricate, as well as estimate cost and time of fabrication before submitting an SFF fabrication job. The first SFF system 102 may further optimize the representation of the job 110 for the target system 104 based on this information. The SDF 206 may be an XML document, or file, in one embodiment of the invention, and a Resource Description Framework (RDF) document, or file, in another embodiment.

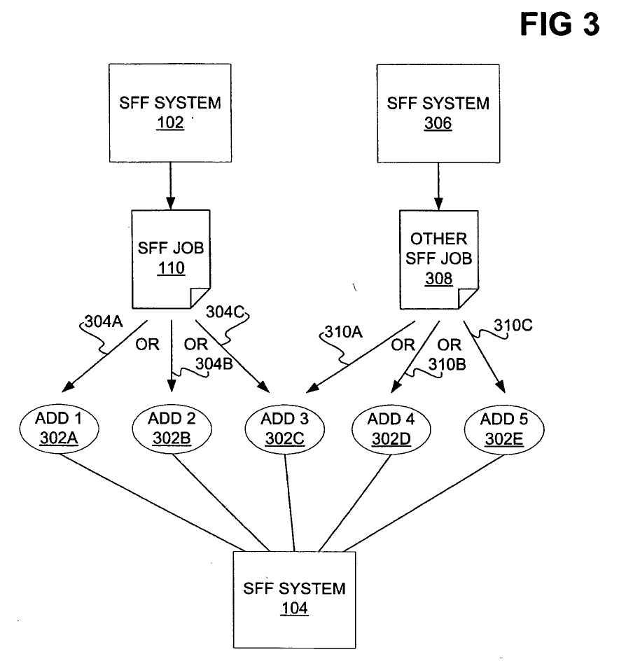

FIG. 3 shows a scenario 300 depicting how the second SFF system 104 can have multiple network addresses 302A, 302B, 302C, 302D, and 302E, collectively referred to as the network addresses 302, according to an embodiment of the invention. The term network address is meant to generally encompass any sort of address of the second SFF system 104 by which it is able to receive SFF fabrication jobs from other systems, like the SFF system 102. For instance, each of the network addresses 302 may be an email address in one embodiment of the invention. Five network addresses 302 are depicted in FIG. 3 for example purposes. In other embodiments, more or fewer of the addresses 302 may be present. The network 106 is not shown in FIG. 1 for illustrative convenience.

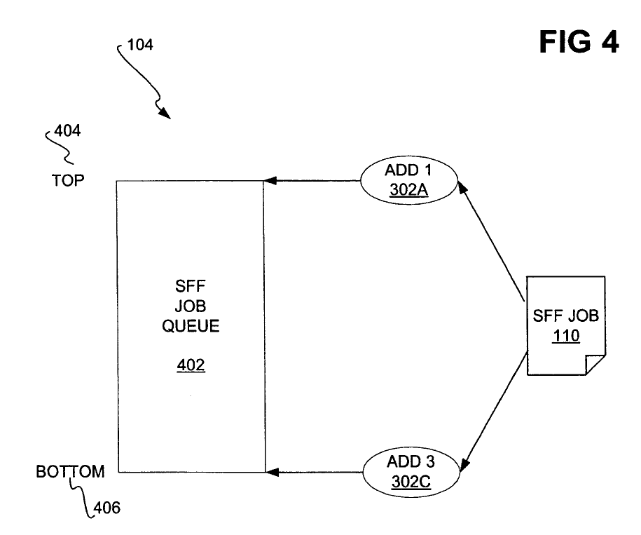

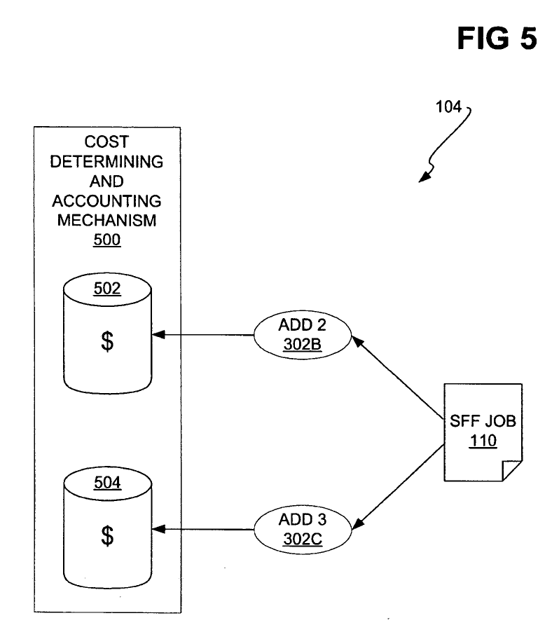

Each of the network addresses 302 is associated with one or more actions to be performed by the second SFF system 104, and/or one or more parameter values to be set by the second SFF system 104, when receiving SFF fabrication jobs at that address. Specific examples of such actions and parameters are described in relation to FIG. 3 later in the detailed description, as well as in relation to FIGS. 4 and 5 later in the detailed description. Furthermore, as depicted in FIG. 3, the network addresses 302A and 302B are intended to receive SFF fabrication jobs from the first SFF system 102, whereas the network addresses 302D and 302E are intended to receive fabrication jobs from another SFF system 306. The network address 302C is a general address, and is intended to receive jobs from any SFF system.

For example, the first SFF system 102 may receive the identities of the network addresses 302A, 302B, and 302C in the SDF 206 of FIG. 2, along with descriptions of what types of SFF fabrication jobs to send to each address. The network address 302A may, for instance, be the address at which the second SFF system 104 is to receive high-priority fabrication jobs from the first SFF system 102. The network address 302B may be the address to which the first SFF system 102 is to send jobs that the cost of fabrication of which is to be deducted against a special account, different from the other accounts associated with the first SFF system 102. As another example, billing rates may be different based on the address to which jobs are sent. The network address 302C may be the address to which the first SFF system 102 is to send jobs with normal priority, and that are not to be deducted against any type of special account.

Therefore, the first SFF system 102 selects to which of the network addresses 302A, 302B, and 302C it should send the SFF fabrication job 110. When receiving the SFF job 110 at either the network address 302A or the network address 302B, the second SFF system 104 verifies that the first SFF system 102 is the sender of the SFF job 110, since the addresses 302A and 302B are reserved for jobs received from the first SFF system 102, or a specific user who just so happens to be using the first SFF system 102. When the second SFF system 104 receives the SFF job 110 at the address 302A, it sets a parameter, specifically, setting the priority level of the SFF job 110 as high. When the SFF system 110 receives the SFF job 110 at the address 302B, it performs an action, specifically, deducting the cost of fabrication of the job 110 from a special account.

The other SFF system 306 similarly selects to which of the network addresses 302C, 302D, and 302E it should send its SFF fabrication job 308. When receiving the SFF job 308 at either the address 302D or the address 302E, the second SFF system 104 verifies that the SFF system 306, or a particular user who just so happens to be using the SFF system 306, is the sender, since the addresses 302D and 302E are reserved for jobs received from the SFF system 306, or a particular user. The network address 302D may be the address at which the second SFF system 104 is to receive high-priority fabrication jobs from the SFF system 306, or from a particular user who just so happens to be using the SFF system 306, whereas the network address 302E may be the address to which the SFF system 306, or a particular user, is to send jobs that the cost of fabrication of which is to be deducted against a special account. Thus, when the second SFF system 104 receives the SFF job 308 at the address 302D, it sets a parameter, the priority level of the SFF job 110, and when it receives the SFF job 308 at the address 302E, it performs an action, determining how much to charge for that job, perhaps at a special rate for that address, and deducting the charge for fabrication of the job 308 from a special account.

FIG. 4 shows how the second SFF system 104 assigns a job priority to the SFF fabrication job 110, depending on the network address of the second SFF system 104 at which the second SFF system 104 receives the job 110, according to an embodiment of the invention. The second SFF system 104 is depicted in FIG. 4 as including an SFF job queue 402, with a top 404 and a bottom 406. SFF fabrication jobs within the queue 402 are processed in order from the top 404 to the bottom 406.

If the SFF fabrication job 110 is received by the second SFF system 104 at the network address 302A, then the second SFF system 104 assigns the job 110 with a high priority. Therefore, the second SFF system 104 inserts the job 110 into the SFF job queue 402 at the top 404 of the queue 402. By comparison, if the SFF fabrication job 110 is received by the second SFF system 104 at the network address 302C, then the second SFF system 104 assigns the job 110 with normal priority. Therefore, the second SFF system 104 inserts the job 110 into the SFF job queue 402 at the bottom 406 of the queue 402, so that it is processed in the order in which it was received relative to other normal priority fabrication jobs. There can be more, or less, than two levels of priority assignable to SFF fabrication jobs. For instance, different addresses may be used so that jobs sent to one address are held for manual review by a supervisor for defect correction before fabrication, and jobs sent to another address are automatically queued for fabrication.

FIG. 5 shows how the second SFF system 104 deducts the fabrication cost of the SFF fabrication job 110 from an account corresponding to or associated with the network address of the second SFF system 104 at which the second SFF system 104 receives the job 110, according to an embodiment of the invention. The second SFF system 104 is depicted in FIG. 5 as including a cost determining and accounting mechanism 500. The mechanism 500 may be implemented in software, hardware, or a combination of software and hardware. As depicted in FIG. 5, the mechanism 500 maintains a first account 502 and a second account 504. Each of the accounts 502 and 504 has an amount of credits, such as a dollar amount, or a synthetic currency such as grams of fabrication material, or units of fabrication machine time. The amount of credits of each of the accounts 502 and 504 may be individually replenished by the corresponding customer of the second SFF system 104.

If the SFF fabrication job 110 is received by the second SFF system 104 at the network address 302B, then the second SFF system 104 determines the cost of fabrication of the job 110, and deducts the first account 502 by this cost. If the account 502 has insufficient credits, or funds, to accommodate the cost of fabrication of the job 110, then the job 110 is not processed until the customer has replenished the funds. Similarly, if the SFF fabrication job 110 is received by the second SFF system 104 determines the cost of fabrication of the job 110, and deducts the second account 504 by this cost. If the account 504 has insufficient credits, or funds, to accommodate the cost of fabrication of the job 110, then the job 110 is not processed until the customer has replenished the funds. The account 504 may be the normal account for a given customer, whereas the account 502 may be the account used by the customer for special projects, in one embodiment of the invention. There can be more, or less, than two accounts from which job fabrication costs are subtracted. If the currency in question is synthetic “machine time” or “grams of material”, the account may hold a quota of such units that is automatically replenished on a regular basis. For example, an individual could be allocated 2000 grams of fabrication a week. At the beginning of the next week, the account is replenished to include 2000 grams.

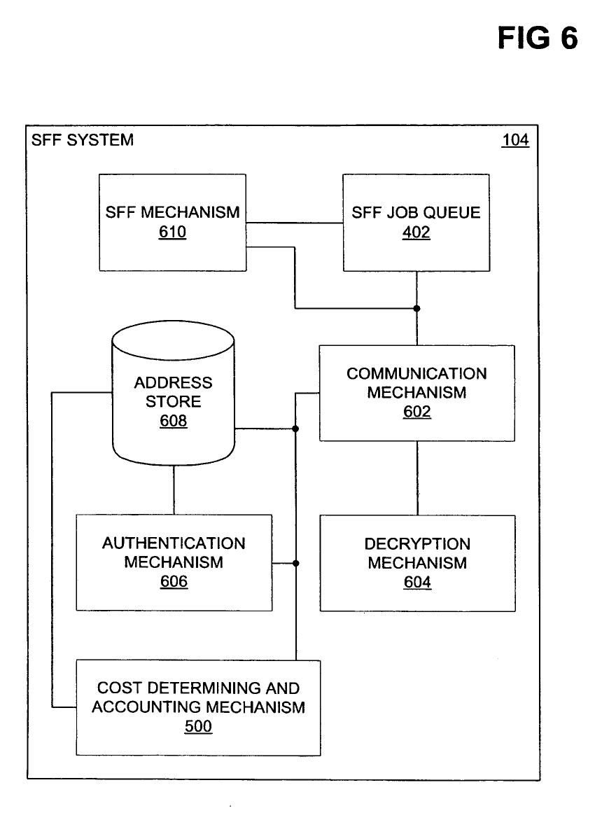

FIG. 6 shows a block diagram of the second SFF system 104 in detail, according to an embodiment of the invention. The second SFF system 104 may also be referred to as an SFF server system in one embodiment of the invention, in that it receives SFF fabrication jobs from users via their SFF systems. The second SFF system 104 is depicted in FIG. 6 as including a communication mechanism 602, a decryption mechanism 604, an authentication mechanism 606, an address store 608, the cost determining and accounting mechanism 500, the SFF job queue 402, and an SFF mechanism 610. The second SFF system 104 may further include other components, in addition to and/or in lieu of those shown in FIG. 6. The description of FIG. 6 is made in relation to the various components of FIG. 1 for descriptive clarity, such as the first SFF system 102, the network 106, and the SFF fabrication job 110. The mechanisms 602, 604, 606, and may each be hardware, software, or a combination of hardware and software, whereas the SFF mechanism 610 may be hardware or a combination of hardware and software.

The communication mechanism 602 may include network adapters and/or other types of communication technologies. The communication mechanism 602 receives the SFF fabrication job 110 from the first SFF system 102 over the network 106. The SFF fabrication job 110 may be received at one of a number of network addresses of the second SFF system 104, as stored in the address store 608. The network addresses may be email addresses in one embodiment of the invention. The communication mechanism 602 may in one embodiment send to the first SFF system 102 over the network 106 the SFF system description file (SDF) 206 of FIG. 2.

If the SFF fabrication job 110 is encrypted, then the communication mechanism 602 passes the fabrication job 110 to the decryption mechanism 604, which decrypts the job 110. Furthermore, if the SFF fabrication job 110 requires authentication, then the communication mechanism 602 passes the fabrication job 110 to the authentication mechanism 606. The authentication mechanism 606 determines the identity of the user of first SFF system 102. If the identity cannot be determined, or the identity is determined but of an unknown individual, then processing of the SFF fabrication job 110 is delayed until the identity can be manually verified. The authentication mechanism 606 can employ digital signatures in one embodiment to determine the identity of the user of first SFF system 102, and in another embodiment use the sending address of the user of first SFF system 102 to determine the identity of the user of device 102.

The address store 608 may be a storage device such as a magnetic storage device, like a hard disk drive, a semiconductor storage device, like flash memory, or another type of storage device, such as a remote storage device accessible over the network 106. The network addresses of the second SFF system 104 stored in the address store 608 may each be associated with one or more actions to be performed by the second SFF system 104 when the SFF fabrication job 110 is received at that address, and/or with one or more parameters to be set by the second SFF system 104 when the fabrication job 110 is received at that address. As an example of the former, the cost determining and accounting mechanism 500 may deduct a job fabrication cost associated with the fabrication job 110 from an amount of credits associated with a given network address, as has been described in relation to FIG. 5, where the cost deduction is an action that is performed. The communication mechanism 602 passes the job 110 to the cost determining and accounting mechanism 500 when such an action is to be performed.

As an example of the latter, the SFF mechanism 610 may set a priority level of the SFF fabrication job 110 corresponding to the priority level accorded a given network address, as has been described in relation to FIG. 4, where the priority level of the job 110 is a parameter that is set. In such instance, each network address stored in the store 608 may be associated with a priority level that is unique relative to the other addresses of the store 608. Thus, fabrication jobs are placed by the SFF mechanism 610 into the SFF job queue 402 when such parameters are to be set. Regardless, however, the communication mechanism 602 passes the SFF fabrication job 110 to the SFF mechanism 610.

The SFF mechanism 610 is the mechanism that actually fabricates a physical object directly from the CAD information of the SFF fabrication job 110, in a layer-by-layer manner. The SFF mechanism 610 may be one or more of a selective laser sintering mechanism, a stereo lithography mechanism, a wide-area thermal inkjet mechanism, a fused deposition modeling mechanism, a single jet inkjet mechanism, a three-dimensional printing mechanism, and/or a laminated object manufacturing mechanism, among other types of SFF mechanisms. The SFF mechanism 610 is to fabricate the physical object directly from the CAD information of the SFF fabrication job 110 without user intervention at the second SFF system 104 in one embodiment, once the communication mechanism 602 has received the fabrication job 110.

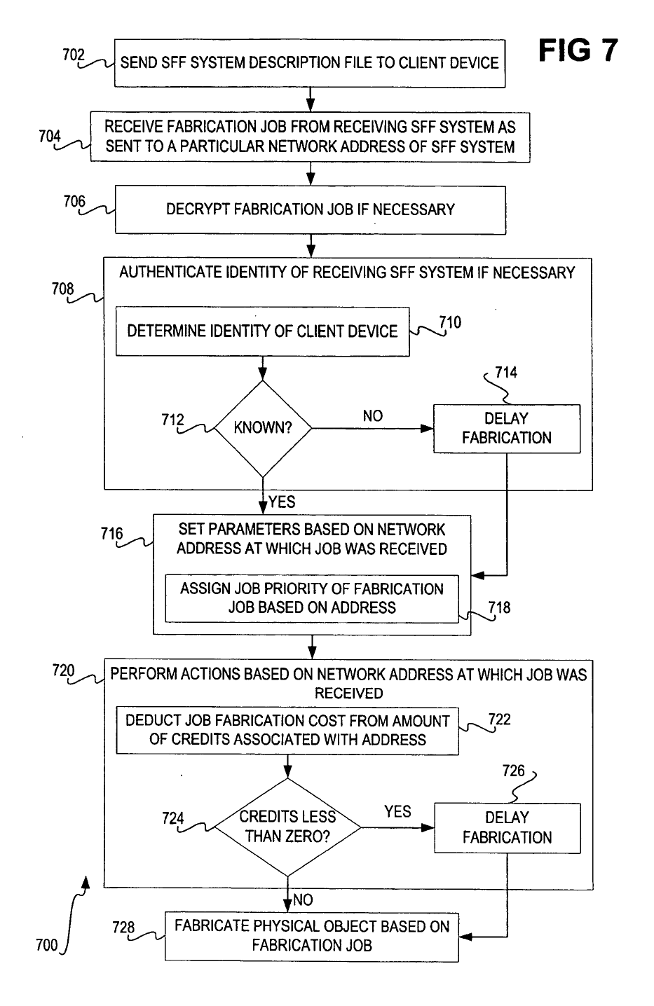

FIG. 7 shows a method 700 that is performable by the second SFF system 104, according to an embodiment of the invention. The second SFF system 104 is described as performing the method 700 relative to the first SFF system 102, the SFF fabrication job 110, and the network 104 of FIG. 1, for descriptive clarity. The method 700 may be implemented as one or more computer program parts of a computer program stored on a computer-readable medium. The medium may be a recordable data storage medium, a modulated carrier signal, or another type of computer-readable medium.

The second SFF system 104 first sends the SFF system description file (SDF) 206 of FIG. 2 to the first SFF system 102 over the network 106 (702), as has been described. Of the network addresses sent by the second SFF system 104 to the first SFF system 102 within the SFF SDF 206, the second SFF system 104 then receives the SFF fabrication job 110 from the first SFF system 102 over the network 106 at a particular one of these addresses (704). Receipt of the SFF fabrication job 110 may be accomplished in a store-and-forward manner, such as via an email message, or relayed over a relay infrastructure such as an instant messaging network. If the fabrication job 110 has been encrypted, then the second SFF system 104 decrypts the fabrication job 110 as necessary (706).

Furthermore, if desired or necessary, the second SFF system 104 authenticates the first SFF system 102 that sent the SFF fabrication job 110 (708). First, the second SFF system 104 determines the identity of the first SFF system 102. For instance, the identity of the first SFF system 102 may be determined as the digital signer of the SFF fabrication job 110, via a digital signature present. As another example, the identity of the first SFF system 102 may be determined as the sender of the email by which the fabrication job 110 was received. If the identity of the first SFF system 102 as has been determined is unknown (712), then fabrication of a physical object in accordance with the job 110 is delayed until the identity can be manually verified (714).

Once the identity of the SFF system has been verified, or if the identity of the first SFF system 102 is initially determined as known (712), then one or more parameters may be set based on the network address at which the SFF fabrication job 110 was received (716). As has been described, for instance, the job priority of the fabrication job 110 may be assigned based on the address at which the job 110 was received (718). Other types of parameters may also be set based on the network address at which the SFF fabrication job 110 was received by the second SFF system 104 from the first SFF system 102 over the network 106.

Next, the second SFF system 104 may perform one or more actions based on the network address at which the SFF fabrication job 110 was received (720). As has been described, for instance, the job fabrication cost of the fabrication job 110 may be deducted from an amount of credits associated with the network address at which the job 110 was received (722). In such instance, if the amount of credits remaining after deduction is less than zero (724), then this means that there is an insufficient number of credits to cover fabrication of a physical object in accordance with the job 110. Therefore, fabrication is delayed until the amount of credits has been replenished (726).

Once the amount of credits has been replenished, or if the amount of credits after deduction is not less than zero (724), then the second SFF system 104 finally fabricates a physical object based on the SFF fabrication job 110 (728). Where fabrication is not delayed in 714 or 726, then the process of the method 700 can be accomplished without any user intervention at the second SFF system 104. For instance, technicians or other personnel do not have to manually load the fabrication job 110 into the second SFF system 104. Thus, fabrication of a physical object in accordance with the fabrication job 110 can begin as soon as possible once the job 110 has been received by the second SFF system 104.

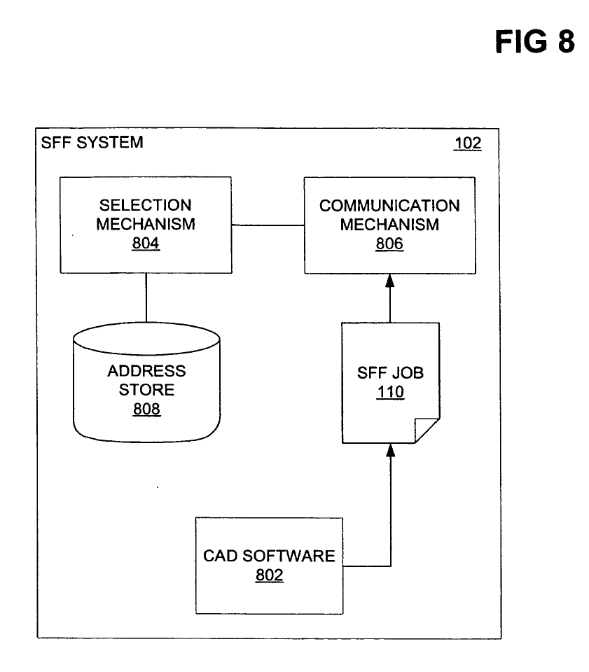

FIG. 8 shows a block diagram of the first SFF system 102 in detail, according to an embodiment of the invention. The first SFF system 102 may also be referred to as an SFF client system in one embodiment of the invention, in that the system 102 sends SFF jobs to the SFF system 104 for fabrication thereat. The first SFF system 102 is depicted in FIG. 8 as including CAD software 802, a selection mechanism 804, a communication mechanism 806, an address store 808, and the SFF fabrication job 110. The first SFF system 102 may further include other components, in addition to and/or in lieu of those shown in FIG. 8. The description of FIG. 8 is made in relation to the various components of FIG. 1 for descriptive clarity, such as the second SFF system 104 and the network 106. The mechanisms 804 and 806 may be hardware, software, or a combination of hardware and software.

The CAD software 802 may be any type of computer-aided drafting software that is capable of generating the SFF fabrication job 110. The term CAD is used in a general sense herein, and encompasses computer-aided engineering (CAE), computer-aided manufacturing (CAM), CAD/CAM, computer-aided drafting and design (CADD), computer-aided design, as well as other types of technologies. That is, the CAD software 802 may be any type of software that is capable of generating the SFF fabrication job 110.

The selection mechanism 804 selects a network address stored in the address store 808 at which the communication mechanism 806 is to send the SFF job 110 to the second SFF system 104 over the network 106. The address store 808 includes network addresses of the second SFF system 104 at which the second SFF system 104 is able to receive the SFF fabrication job 110 from the first SFF system 102. For instance, these network addresses may have been received by the communication mechanism 806 of the first SFF system 102 from the second SFF system 104 over the network 106 in the SFF system description file (SDF) 206 of FIG. 2, as has been described.

The selection mechanism 804 may select one of the network addresses of the address store 808 based on a desired action to be performed by the second SFF system 104 when receiving the SFF job 110 at the address, and/or based on a desired parameter to be performed by the second SFF system 104 when receiving the SFF job 110 at the address. An example of a desired action to be performed by the second SFF system 104 is the deduction of the fabrication cost of the job 110 from a particular account, as has been described in relation to FIG. 5. An example of a desired parameter to be set by the second SFF system 104 is the setting of the priority level of the job 110 to a particular priority, as has been described in relation to FIG. 4. Thus, the network addresses of the address store 808 may each be associated with actions to be performed by the second SFF system 104 and/or parameters to be sent by the second SFF system 104, when the SFF job 110 is sent to the second SFF system 104 at a given network address.

The communication mechanism 802 may include network adapters and/or other types of communication technologies. The communication mechanism 802 receives the SFF system description file (SDF) 206 of FIG. 2 from the second SFF system 104 over the network 106, and also sends the SFF job 110 generated by the CAD software 802 to the second SFF system 104 over the network 806. If desired or required, the communication mechanism 802 may initially digitally sign and/or encrypt the SFF fabrication job 110 prior to sending it to the second SFF system 104. For instance, if the second SFF system 104 requires authentication of job senders, then digitally signing the SFF job 110 with a digital signature may be necessary. As another example, for added security during transport over the network 106, the SFF job 110 may be encrypted with a public key of the second SFF system 104. The public key may have been earlier received within the SFF SDF 206 of FIG. 2 in one embodiment.

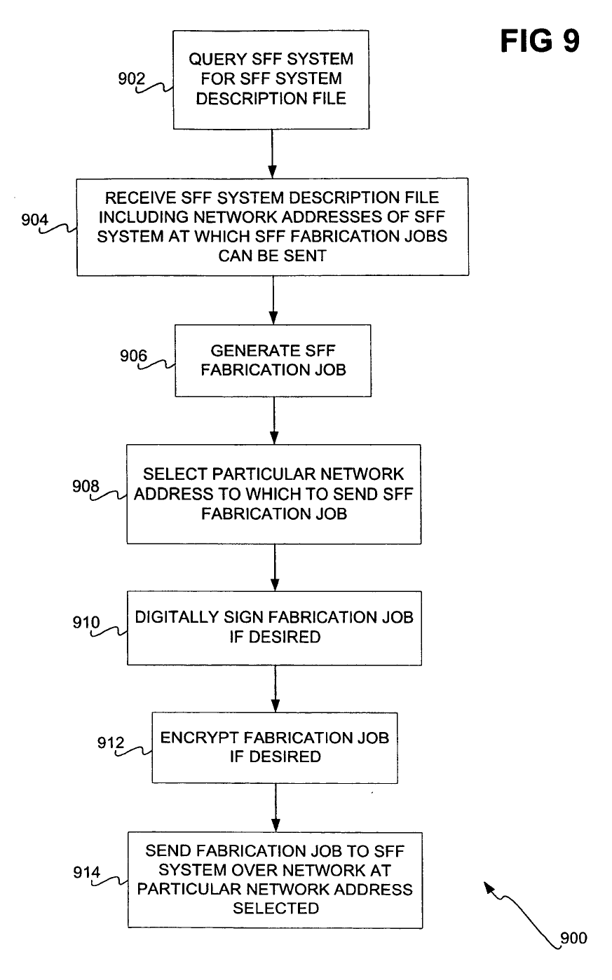

FIG. 9 shows a method 900 that is performable by the first SFF system 102, according to an embodiment of the invention. The first SFF system 102 is described as performing the method 900 relative to the second SFF system 104, the SFF fabrication job 110, and the network 104 of FIG. 1, for descriptive clarity. In particular, one or more application computer programs of the first SFF system 102, such as part of or including the communication mechanism 806, the selection mechanism 804, and the CAD software 802 of FIG. 8, may perform the method 900. The method 900 may further be implemented as one or more computer program parts of a computer program stored on a computer-readable medium. The medium may be a recordable data storage medium, a modulated carrier signal, or another type of computer-readable medium.

The first SFF system 102 queries the second SFF system 104 over the network 106 for the SFF system description file (SDF) 206 of FIG. 2 (902). In response, the first SFF system 102 receives from the second SFF system 104 over the network the SFF SDF 206 (904). The SFF SDF 206 includes the network addresses of the second SFF system 104 at which the first SFF system 102 is able to send the SFF fabrication job 110 for fabrication of a physical object in accordance therewith by the second SFF system 104. The SFF SDF 206 may further include other information, such as the public encryption key of the second SFF system 104, and so on, as has been described.

The first SFF system 102 next generates the SFF fabrication job 110 (906), and selects a particular one of the network addresses within the SFF SDF 206 at which to send the SFF job 110 to the second SFF system 104 over the network 106 (908). As has been described, such address selection may be based on a selected action to be performed by the second SFF system 104 when receiving the SFF job 110 at a given address, and/or on a parameter to be set by the second SFF system 104 when receiving the SFF job 110 at a given address. An example of a selected action is the deduction of the job fabrication cost of the SFF job 110 from a particular account, as has been described in relation to FIG. 5. An example of a selected parameter is the assigning of the job priority level of the SFF job 110 with a particular priority, as has been described in relation to FIG. 4.

The SFF fabrication job 110 is digitally signed if desired (910), such as if the second SFF system 104 requires that the fabrication job 110 be received as so digitally signed. Digitally signing is accomplished with a digital signature of the first SFF system 102. Next, the fabrication job 110 is encrypted if desired (912), such as if added security is wanted. Encryption is accomplished with a public encryption key of the second SFF system 104. Finally, the first SFF system 102 sends the SFF fabrication job 110 at the particular network address selected to the second SFF system 104 over the network 106 (914). Such transmission of the SFF fabrication job 110 can be accomplished in a store-and-forward manner, such as by sending an email message including the fabrication job 110.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

1. A method comprising:
receiving a fabrication job over a network from a first solid freeform fabrication (SFF) system, by a second SFF system; and,
fabricating a physical object based on the fabrication job received, by the second SFF system, without user intervention in loading the fabrication job into the second SFF system.

2. The method of claim 1, wherein the second SFF system receives the fabrication job from the first SFF system over the network in a store-and-forward manner.

3. The method of claim 2, wherein the second SFF system receives the fabrication job from the first SFF system via an email message.

4. The method of claim 1, further comprising initially sending by the second SFF system to the first SFF system over the network an SFF system description file including an address of the second SFF system to which the first SFF system is to send the fabrication job to the second SFF system over the network, wherein the first SFF system has already received an invitation from the second SFF system to request the second SFF system description file.

5. The method of claim 1, wherein the fabrication job received over the network by the second SFF system from the first SFF system is encrypted, the method further comprising decrypting the fabrication job by the second SFF system after receipt.

6. The method of claim 1, further comprising:
determining by the second SFF system of an identity of a user the first SFF system that sent the fabrication job;
where the identity of the user of the first SFF system is known, fabricating the physical object based on the fabrication job received; and,
where the identity of the user of the first SFF system is unknown, delaying fabrication of the physical object based on the fabrication job received until the identity of the user of the first SFF system can be verified.

7. The method of claim 1, wherein the fabrication job received over the network by the second SFF system from the first SFF system is digitally signed, the method further comprising:
determining by the second SFF system of an identity of a digital signer of the fabrication job;
where the identity of the digital signer is known, fabricating the physical object based on the fabrication job received; and,
where the identity of the digital signer is unknown, delaying fabrication of the physical object based on the fabrication job received until the identity of the digital signer can be verified.

8. The method of claim 1, wherein the fabrication job received over the network by the second SFF system is sent by the first SFF system to a particular address of a plurality of addresses of the second SFF system, the method further comprising:
assigning a job priority of the fabrication job based on the particular address of the second SFF system to which the fabrication job was sent by the first SFF system, each of the plurality of addresses having a unique priority level relative to other of the plurality of addresses to which to assign fabrication jobs sent thereto.

9. The method of claim 1, wherein the fabrication job received over the network by the second SFF system is sent by the first SFF system to a particular address of a plurality of addresses of the second SFF system, the method further comprising:
determining a job fabrication cost associated with the fabrication job and deducting the cost from an amount of credits associated with the particular address of the second SFF system to which the fabrication job was sent by the first SFF system, each of the plurality of addresses having associated therewith at least one of a: corresponding amount of credits and a cost of usage; and,
where the amount of credits associated with the particular address of the second SFF system to which the fabrication job was sent by the first SFF system is negative, delaying fabrication of the physical object based on the fabrication job received until the amount of credits has been replenished.

10. The method of claim 1, wherein the second SFF system is one or more of: a rapid prototyping mechanism, a selective laser sintering mechanism, a stereo lithography mechanism, a wide-area thermal inkjet mechanism, a fused deposition modeling mechanism, a single jet inkjet mechanism, a three-dimensional printing mechanism, and a laminated object manufacturing mechanism.

11. A solid freeform fabrication (SFF) system comprising:
an SFF mechanism to fabricate a physical object directly from computer-aided drafting (CAD) information of a fabrication job in a layer-by-layer manner;
a store of a plurality of addresses of the SFF system, each address associated with at least one of: one or more actions, and one or more parameter values; and,
a communication mechanism to receive the fabrication job at a particular address of the plurality of addresses from another system over a network,
wherein the SFF system is to at least one of: perform the one or more actions associated with the particular address at which the fabrication job was received; and, set the one or more parameter values associated with the particular address at which the fabrication job was received.

12. The SFF system of claim 11, wherein the SFF mechanism is to fabricate the physical object directly from the CAD information of the fabrication job without user intervention upon the communication mechanism having received the fabrication job from the other system over the network.

13. The SFF system of claim 11, wherein the communication mechanism is further to send to the other system over the network an SFF system description file including at least the particular address to which the other system can send the fabrication job to the SFF system over the network.

14. The SFF system of claim 11, wherein the plurality of addresses comprises a plurality of email addresses, such that the communication mechanism is to receive the fabrication job from an email sent by the other system over the network.

15. The SFF system of claim 11, further comprising an authentication mechanism to determine an identity of the other system, such that where the identity of the other system is unknown, fabrication of the physical object by the SFF mechanism is delayed until the identity of the other system can be verified.

16. The SFF system of claim 15, wherein the authentication mechanism employs digital signatures to determine the identity of the other system.

17. The SFF system of claim 11, further comprising a decryption mechanism to decrypt the fabrication job where the fabrication job has been encrypted by the other system.

18. The SFF system of claim 11, wherein the one or more parameters associated with each of the plurality of addresses comprises a unique priority level relative to other of the plurality of addresses, such that the SFF mechanism is to set a priority level of the fabrication job in accordance with the particular address at which the fabrication job was received.

19. The SFF system of claim 11, wherein the one or more actions associated with the particular address at which the fabrication job was received comprises deducting a job fabrication cost associated with the fabrication job from an amount of credits associated with the particular address, such that, where the amount of credits associated with the particular address is negative, the SFF mechanism delays fabrication of the physical object based on the fabrication job until the amounts of credits has been replenished.

20. The SFF system of claim 11, wherein the SFF mechanism is one or more of: a rapid prototyping mechanism, a selective laser sintering mechanism, a stereo lithography mechanism, a wide-area thermal inkjet mechanism, a fused deposition modeling mechanism, a single jet inkjet mechanism, a three-dimensional printing mechanism, and a laminated object manufacturing mechanism.

21. A solid freeform fabrication (SFF) system comprising:
means for receiving a fabrication job from another system over a network; and,
means for fabricating a physical object directly from computer-aided drafting (CAD) information of the fabrication job in a layer-by-layer manner, without user intervention.

22. The SFF system of claim 21, further comprising means for sending the other system over the network an SFF system description file including an address of the SFF system to which the other system is to send the fabrication job to the SFF system over the network.

23. The SFF system of claim 21, further comprising means for storing of a plurality of addresses of the SFF system, each address associated with at least one of: one or more actions, and one or more parameter values, wherein the means for receiving receives the fabrication job at a particular address of the plurality of addresses from the other system over the network.

24. The SFF system of claim 23, wherein the means for fabricating is further for at least one of: performing the one or more actions associated with the particular address at which the fabrication job was received; and, setting the one or more parameter values associated with the particular address at which the fabrication job was received.

25. The SFF system of claim 23, wherein the one or more parameters associated with each of the plurality of addresses comprises a unique priority level relative to other of the plurality of addresses, such that the means for fabricating is further for setting a priority level of the fabrication job in accordance with the particular address at which the fabrication job was received.

26. The SFF system of claim 23, wherein the one or more actions associated with the particular address at which the fabrication job was received comprises deducting a job fabrication cost associated with the fabrication job from an amount of credits associated with the particular address, such that, where the amount of credits associated with the particular address is negative, the means for fabricating is further for delaying fabrication of the physical object based on the fabrication job until the amounts of credits has been replenished.

27. A computer-readable medium having a computer program stored thereon for execution at a solid freeform fabrication (SFF) system, the computer program comprising:
a first computer program part to receive a fabrication job at a particular address of a plurality of address from another system over a network, each address associated with at least one of: one or more actions, and one or more parameter values; and,
a second computer program part to send to the other system over the network an SFF system description file including at least the particular address to which the other system is able to send the fabrication job to the SFF system over the network.

28. The medium of claim 27, the computer program further comprising a third computer program part to determine an identity of a user of the other system, such that where the identity of the user of the other system is unknown, fabrication of a physical object based on the fabrication job is delayed until the identity of the user of the other system can be verified.

29. A method comprising:
receiving by a first solid freeform fabrication (SFF) system, from a second SFF system over a network, a plurality of addresses of the second SFF system at which the second SFF system is able to receive fabrication jobs over the network, each address associated with at least one of: one or more actions to be performed by the second SFF system when receiving a fabrication job at the address, and one or more parameter values to be set by the second SFF system when receiving a fabrication job at the address;
selecting a particular address from the plurality of addresses at which to send the second SFF system a particular fabrication job over the network by the first SFF system, based on at least one of: a selected action to be performed by the second SFF system when receiving the particular fabrication job at the address, and a selected parameter value to be set by the second SFF system when receiving the particular fabrication job at the address; and,
sending the particular fabrication job to the second SFF system at the particular address selected, over the network.

30. The method of claim 29, wherein receiving the plurality of addresses of the second SFF system comprises receiving an second SFF system description file including the plurality of addresses of the second SFF system.

31. The method of claim 29, wherein receiving the plurality of addresses of the second SFF system comprises the first SFF system querying the second SFF system over the network.

32. The method of claim 29, wherein each address is associated with a unique priority level relative to unique priority levels of other of the plurality of addresses, selecting the particular address comprising selecting the particular address based on the unique priority level associated therewith, such that the second SFF system is to assign the particular fabrication job a job priority equal to the unique priority level associated with the particular address upon receiving the particular fabrication job at the particular address from the first SFF system over the network.

33. The method of claim 29, wherein each address is associated with a corresponding amount of credits, selecting the particular address comprising selecting the particular address based on the corresponding amount of credits associated therewith, such that the second SFF system is to deduct a job fabrication cost associated with the particular fabrication job from the corresponding amount of credits associated with the particular address upon receiving the particular fabrication job at the particular address from the first SFF system over the network.

34. The method of claim 29, wherein sending the particular job to the second SFF system at the particular address selected, over the network, is accomplished in at least one of: a store-and-forward manner and a relay manner.

35. The method of claim 29, wherein sending the particular job to the second SFF system at the particular address selected, over the network, is accomplished by sending an email message including the particular job.

36. The method of claim 29, further comprising encrypting the particular fabrication job prior to sending the particular fabrication job to the second SFF system at the particular address selected, over the network.

37. The method of claim 29, further comprising digitally signing the particular fabrication job prior to sending the particular fabrication job to the second SFF system at the particular address selected, over the network.

38. A solid freeform fabrication (SFF) system comprising:
a store of a plurality of addresses of a second SFF system at which the second SFF system is able to receive fabrication jobs over a network from the SFF system; and,
a communication mechanism to send a fabrication job to the second SFF system at a selected address of the plurality of addresses over the network.

39. The SFF system of claim 38, wherein each address is associated with at least one of: one or more actions to be performed by the second SFF system when receiving a fabrication job at the address, and one or more parameter values to be set by the second SFF system when receiving a fabrication job at the address.

40. The SFF system of claim 39, wherein the SFF system further comprises a selection mechanism to select the selected address based on at least one of: a selected action to be performed by the second SFF system when receiving the fabrication job at the address, and a selected parameter value to be set by the second SFF system when receiving the fabrication job at the address.

41. The SFF system of claim 39, wherein each address is associated with a unique priority level relative to unique priority levels of other of the plurality of addresses, selecting the selected address comprising selecting the selected address based on the unique priority level associated therewith, such that the second SFF system is to assign the fabrication job a job priority equal to the unique priority level associated with the selected address upon receiving the fabrication job at the selected address from the SFF system over the network.

42. The SFF system of claim 39, wherein each address is associated with a corresponding amount of credits, selecting the selected address comprising selecting the selected address based on the corresponding amount of credits associated therewith, such that the second SFF system is to deduct a job fabrication cost associated with the fabrication job from the corresponding amount of credits associated with the selected address upon receiving the fabrication job at the selected address from the SFF system over the network.

43. The SFF system of claim 38, wherein the communication mechanism is to at least one of digitally sign and encrypt the fabrication job prior to sending the fabrication job to the second SFF system.

44. The SFF system of claim 38, wherein the communication mechanism is further to receive an SFF description file from the second SFF system over the network, the SFF description file including the plurality of addresses to be stored in the store.

45. A solid freeform fabrication (SFF) system comprising:
means for storing a plurality of address of a second SFF system at which the second SFF system is able to receive fabrication jobs over a network from the SFF system, each address associated with at least one of: one or more actions to be performed by the second SFF system when receiving a fabrication job at the address, and one or more parameter values to be set by the second SFF system when receiving a fabrication job at the address;
means for selecting a selected address at which to send a fabrication job to the second SFF system over the network, based on at least one of: a selected action to be performed by the second SFF system when receiving the fabrication job at the address, and a selected parameter value to be set by the second SFF system when receiving the fabrication job at the address; and,
means for sending the fabrication job to the second SFF system at the selected address over the network.

46. A computer-readable medium having a computer program stored thereon for execution at a solid freeform fabrication (SFF) system, the computer program comprising:
a first computer program part to select a selected address from a plurality of addresses at which to send a fabrication job to a second SFF system over a network, each address associated with at least one of: one or more actions to be performed by the second SFF system when receiving a fabrication job at the address, and one or more parameter values to be set by the second SFF system when receiving a fabrication job at the address; and,
a second computer program part to send the fabrication job to the second SFF system at the selected address over the network.

47. The medium of claim 46, herein the first computer program part is to select the selected address based at least on one of: a selected action to be performed by the second SFF system when receiving the fabrication job at the address, and a selected parameter value to be set by the second SFF system when receiving the fabrication job at the address.
